(19) United States
(12) Patent Application Publication
(10) Pub. No.: US 2017/0091751 A1
(43) Pub. Date: Mar. 30, 2017

(54) SYSTEM FOR PROMOTING ONLINE FABRIC SAMPLING

(71) Applicant: Edward Jonathan WOLLSTEIN, Johns Creek, GA (US)

(72) Inventor: Edward Jonathan WOLLSTEIN, Johns Creek, GA (US)

(21) Appl. No.: 14/867,101

(22) Filed: Sep. 28, 2015

(51) Int. Cl. G06Q 20/22; G06Q 20/12; G06Q 10/08; G06Q 30/06; G06Q 20/24

(52) U.S. Cl. CPC G06Q 20/29; G06Q 30/0643; G06Q 20/24; G06Q 10/083; G06Q 20/12

(57) ABSTRACT

A system embodying a method for promoting online sampling of fabric, and in turn promoting the design process is provided. The system includes a website including an operatively linked accounting and crediting systems. The account system enables creation of a plurality of identifiable accounts, each associated with a registered customer, wherein purchases of cut samples of fabric stock are storable as a credited amount in a credited amount account. The crediting system enables the registered customer to purchase by-the-yard fabric stock reduced by up to the total credited amount stored in their credited amount account. As a result, the final fabric cost equaling the fabric cost before credit less the credited amount, thereby promoting the creative design process of the registered users.

### BACKGROUND OF THE INVENTION

The present invention relates to systems and method of sampling products and, more particularly, to a system embodying a method for promoting online sampling of fabric, and in turn promoting the design process.

Purchasing textile fabric usually involves buying fabric stock priced by the yard. If visiting a brick-and-mortar fabric store, this does not impose a prohibitive risk because prospective buyers can bring in cuttings of a desired fabric to directly compare against the store's inventory, readily confirming the accuracy of colors and feel of the textures between cuttings and inventory. In contrast, prospective buyers face a more imposing risk when buying by-the-yard textiles over the Internet. The comparison of color accuracy is usually not precisely represented via computer monitor and the buyer cannot feel the texture of the fabric. To rectify this, these would-be buyers purchase fabric samples. However, people often do not order the amounts of samples required for their design projects because they have to pay for the samples quasi-sight unseen, and some online retailers limit the amount of samples they can purchase or the inventory from which they can cut samples from. This hurts the creative design process by limiting online consumer-designers' options.

As can be seen, there is a need for a system embodying a method for promoting online sampling of fabric, and in turn promoting the design process.

### SUMMARY OF THE INVENTION

In one aspect of the present invention, a computer-implemented, online method of promoting online sampling of fabric includes providing a visual representation of a plurality of fabric stock; associating by-the-yard and sample unit costs with each fabric stock; receiving and storing payments for each sample unit cost in an accruing credited amount account associated with a registered user; and crediting a payment for a predetermined by-the-yard cost by a predetermined credit, wherein the predetermined credit is as much as or less then the currently stored payments in the credited amount account.

In another aspect of the present invention, a computer-implemented, online method of promoting online sampling of fabric includes providing a visual representation of a plurality of fabric stock; associating by-the-yard and sample unit costs with each fabric stock; receiving and storing payments for each sample unit cost in an accruing credited amount account associated with a registered user; shipping each paid-for sample unit to said registered user; crediting a payment for a predetermined by-the-yard cost by a predetermined credit, wherein the predetermined credit is as much as or less then the currently stored payments in the credited amount account; and deducting the credited amount account by the predetermined credit, wherein each sample unit cost includes any shipping costs of taxes associated with the paying for and the shipping of the underlying sample unit.

In yet another aspect of the present invention, a method of promoting online sampling of fabric includes associating each fabric with a before credit cost and a samples cost; receiving and storing payments for each samples cost from a plurality of fabrics in an accruing credited amount account associated with a customer; and reducing the before credit cost by at least the samples costs accrued in the credit amount account, whereby the customer pays only the final fabric cost.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention; and

FIG. 2 is a flow chart of an exemplary embodiment of the present invention.

### ITEMIZED PARTS LIST

10: is the website
12: is the samples cost
14: are the cut samples
16: is the customer
18: is the fabric cost before credit
20: is the credited amount
22: is the final fabric cost
24: is the fabric

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system embodying a method for promoting online sampling of fabric, and in turn promoting the design process. The system provides a proprietary online platform including an operatively linked accounting and crediting systems. The account system enables creation of a plurality of identifiable accounts, each associated with a registered user and a plurality of accounts for transferring and storing units of credit, wherein purchases of unit samples of fabric stock are storable in a credited amount account. The crediting system enables purchases of by-the-yard fabric stock reduced by up to the units of credit stored in the credited amount account, thereby promoting the creative design process of the registered users.

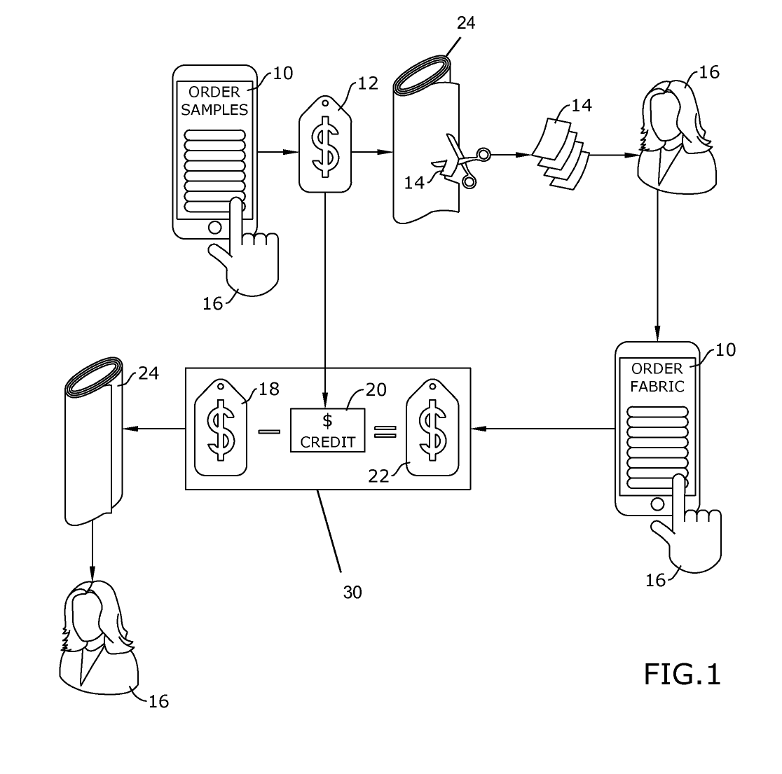

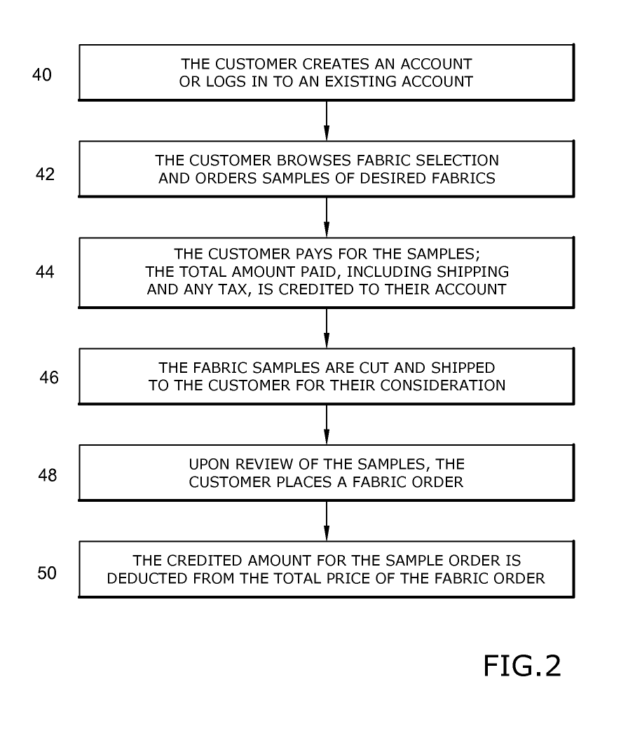

Referring to FIGS. 1 and 2, the present invention may include a website 10, such as an e-commerce platform or other virtual site accessible over the Internet, owned and controlled by an enterprise. The website 10 may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The website 10 may be adapted to include an accounting system having a plurality of identifiable accounts. Each identifiable account may be associated with a customer 16 or registered user who has properly registered with the website 10 and a predetermined number of guests thereof. Each identifiable account may include at least one credit account adapted to receive, verify, store, and distribute units of credit from, for and to its customer 16. The units of credit may have a redeemable, monetary value. Each credit account may include at least an enterprise account and a credited amount account.

The website 10 may provide visual representations of a plurality of fabric 24 (or fabric stock) for purchase. Each fabric 24 may be a by-the-yard quantity of any fabric, including but not limited to textile, used in the design and fabrication of clothing, home and personal accessories and the like. Each fabric 24 may be cut into a plurality of smaller cut samples 14 or sample units, each may be by-the-inch quantity. Accordingly, the website 10 may associate each fabric 24 with a fabric cost before credit 18 (or by-the-yard cost) and a samples cost 12 (or sample unit cost). The website 10 may be adapted so that the registered user may transmit units of credit for such costs to their credit account of their identifiable account. The website 10 may be adapted so that each transfer (“payment”) regarding each samples cost 12 is stored as a credited amount 20 within the credited amount account. The accounting system may be adapted to retrievably track a summation and/or accrual of at least one credited amount 20 currently stored within the credited amount account.

The website 10 may be adapted to disperse the units of credit stored in each enterprise account directly or indirectly to the controlling enterprise. The website 10 may provide a crediting system 30 operatively connected to the accounting system. The crediting system 30 may be adapted to reduce the fabric cost before credit 18 for each fabric 24 by a predetermined credit up to the summation of the currently stored (and non-dispersed) credited amount 20 in the credited amount account for the associated customer 16, whereby amount of the predetermined credit is dispersed into the enterprise account along with a final fabric cost 22, paid directly from the customer 16 to the enterprise account. In certain embodiments, each identifiable account may provide a balance account, wherein the registered user may store units of credit to transfer directly to the enterprise account for paying the fabric cost before credit 18 and/or the final fabric cost 22, or transfer directly to the credited amount account for at least one samples cost 12.

In other words, the website 10 has a sampling process where the samples unit costs 12 are a fixed value. For every cut samples 14 the customer 16 orders from the visually represented inventory of fabric 24, the samples unit costs 12 is converted to a credited amount 20 that is credited to their credited amount account. This summed credited amount 20 can then be used at a future date to purchase from the fabric 24 inventory on the website 10. This effectively makes the sample process free and allows the customer 16 to virtually cut samples unit 14 freely and casually. This functionality benefits the creative design process.

Every samples cost 12 amounts to a credited amount 20. This means the customer 16 now has an outstanding balance in their credit account which they will want to use. The customer 16 may now virtually cut cut samples 14 unimpeded because they know everything they spend on the cut samples 14 will be applied to their fabric cost before credit 18 resulting in a reduced final fabric cost 22. They would receive the cut samples 14 in the mail and use them to make their design decisions. Once they had made these decisions they would go back to the website 10 and order a desired fabric 24 by the yard. This will bring them back to the website 10 to spend their credited amount 20, most likely on one of the fabric 24 of which they already ordered a cut samples 14.

A method of using the present invention may include the following. The website 10 disclosed above may be provided. A user may become a customer 16, in step 40. Then the customer 16 may browse the fabric 24 inventory and order at least one sample unit of at least one fabric 24, in step 42. In step 44, the customer 16 may transfer units of credit for the total samples cost 12, for the at least one cut samples 14, directly to the credited amount account or indirectly through their balance account. In certain embodiments, the total samples cost 12 may include shipping and any tax payable. In step 46, the at least one cut samples 14 are shipped to the customer 16 for their design considerations. In step 48, upon review of the at least one cut samples 14, the customer 16 places an order by-the-yard for the desired fabric 24 by paying for the fabric cost before credit 18 directly or through their balance account. Alternatively, in step 50, the customer 16 may offset the fabric cost before credit 18 by up to the summation of accrued credited amount 20 stored in the credited amount account, that has not yet been disperse, resulting in a reduced payment of final fabric cost 22.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer-implemented method of promoting online sampling of fabric, comprising the steps of:
providing a visual representation of a plurality of fabric stock;
associating by-the-yard and sample unit costs with each fabric stock;
receiving and storing payments for each sample unit cost in an accruing credited amount account associated with a registered user; and
crediting a payment for a predetermined by-the-yard cost by a predetermined credit, wherein the predetermined credit is as much as or less then the currently stored payments in the credited amount account.

2. The method of claim 1, further comprising the step of shipping each paid-for sample unit to the registered user.

3. The method of claim 2, wherein each sample unit cost includes any shipping costs of taxes associated with the paying for and the shipping of the underlying sample unit.

4. The method of claim 1, further comprising the step of shipping each paid-for sample unit to the registered user.

5. The method of claim 1, further comprising the step of deducting the credited amount account by the predetermined credit.

6. A computer-implemented method of promoting online sampling of fabric, comprising the steps of:
providing a visual representation of a plurality of fabric stock;
associating by-the-yard and sample unit costs with each fabric stock;
receiving and storing payments for each sample unit cost in an accruing credited amount account associated with a registered user;
shipping each paid-for sample unit to said registered user;
crediting a payment for a predetermined by-the-yard cost by a predetermined credit, wherein the predetermined credit is as much as or less then the currently stored payments in the credited amount account; and
deducting the credited amount account by the predetermined credit,
wherein each sample unit cost includes any shipping costs of taxes associated with the paying for and the shipping of the underlying sample unit.

7. A method of promoting online sampling of fabric, comprising the steps of:
associating each fabric with a before credit cost and a samples cost;
receiving and storing payments for each samples cost from a plurality of fabrics in an accruing credited amount account associated with a customer; and
reducing the before credit cost by at least the samples costs accrued in the credit amount account,
whereby the customer pays only the final fabric cost.
